(19) United States
(12) Patent Application Publication
(10) Pub. No.: US 2011/0282050 A1
(43) Pub. Date: Nov. 17, 2011

(54) METHOD OF PREPARING ALKALI CELLULOSE OR A CELLULOSE DERIVATIVE

(76) Inventors: Gunnar R. Merz, Stade (DE); Hans-Peter Schneider, Stade (DE); Wolfgang Beer, Houston, TX (US)

(21) Appl. No.: 12/524,466

(22) PCT Filed: Nov. 30, 2007
(86) PCT No.: PCT/US07/85993

§ 371 Date: Dec. 4, 2009

(51) Int. Cl. C08B 11/193

(52) U.S. Cl. 536/91

(57) ABSTRACT

The throughput of a reactor for producing alkali cellulose and/or a cellulose derivative can be increased by using a granulated cellulose-based material for the preparation of alkali cellulose and/or a cellulose derivative. Cellulose derivatives of essentially the same quality can be produced as in known processes wherein powdered cellulose-based material is used for alkalization and derivatization.

The present invention refers to an improved process for preparing alkali cellulose or a cellulose derivative.

### BACKGROUND OF THE INVENTION

Wood and other lignocelluloses, such as straw or other annual plants consist of many different cell types in which cellulose, hemicelluloses, and lignin are the main chemical components. In contact with an aqueous chemical digestion liquor, lignin, which is embedded predominantly between the wood fibers as a binder and in the outer cell wall layers, and the hemicelluloses are largely dissolved out of the fiber matrix. The cohesion of the structural elements is lost in this process. The fibrous material obtained after digestion, consisting principally of cellulose, is called pulp. The obtained aqueous fiber suspension is washed, screened, optionally bleached, dewatered and dried. In conventional dewatering and drying processes a single-layer sheet of pulp is formed, dried and marketed, typically in the form of rolls. The pulping process is described in detail in Ullmann's encyclopedia of Industrial Chemistry, Copyright © 2002 by Wiley-VCH Verlag GmbH & Co. KGaA., DOI: 10.1002/14356007.a18_{—}545, in the Online Article “Paper and Pulp” with the Posting Date Jun. 15, 2000, pages 14-35. Useful pulping processes are, for example, alkaline pulping processes, Kraft pulping, or the sulfite process.

For the manufacture of cellulose derivatives, such as cellulose ethers or cellulose esters, cellulose-based material is provided in form of fine particles which are contacted with an alkali solution before derivatisation. For the preparation of the fine cellulose-based particles dry cellulose pulp in the form of sheets or bales can be used. The sheets can be in the form of endless roles or can be cut in individual pieces. The sheets or bales are fed into the intake of a cellulose grinder to be ground into cellulose powder. In many cases the grinders are cutting mills, such as knife mills. The grinders usually have a screen or sieve in the outlet to control the particle size of the obtained product.

The cellulose powder is transferred into a reactor vessel and contacted with an alkali solution to obtain alkali cellulose which can be further reacted to obtain cellulose derivatives, like ethers or esters. Useful processes to obtain cellulose derivatives, such as cellulose ethers or esters are known in the art and can be reviewed for example in Ullmanns Encyclopedia of Industrial Chemistry 5^{th} completely revised Edition VCH Verlagsgesellschaft mbH Weinheim 1986, Vol. 15, p 461-487; Das Papier 12/1997, p 653-660; or U.S. Pat. No. 4,456,751.

In industrial production alkali cellulose and cellulose derivatives are produced on large scale. Industrial scale batch reactors can have sizes from several hundred liters to several cubic meters. Accordingly, the reactors require a lot of capital and the industry is constantly searching for processes to achieve high quality cellulose derivatives while reducing the capital required for the derivatization process.

The skilled artisans seek to achieve an intimate contact of the cellulose with an alkali solution and a uniform distribution of the alkali solution in the cellulose to avoid fractions of non-reacted cellulose. US-A 2002/0099203 discusses various ways of contacting cellulose with an alkali solution and its disadvantages. One way of producing alkali cellulose is to dip a sheet of dried pulp in an aqueous solution of sodium hydroxide, to allow the pulp to absorb sufficient amount of alkali and to press the pulp to remove excess alkali. However, this process is not very productive. A more productive process is to grind the sheet of dried pulp to a powder and to add a predetermined amount of alkali to the powdered dried pulp. To obtain a uniform distribution of alkali in the alkali cellulose, US-A 2002/0099203 describes a process for the production of alkali cellulose and cellulose ether, wherein the cellulose is charged in dried powder form into a double-shaft kneader and contacted with an aqueous alkali solution under intensive agitation. US-A 2002/0099203 teaches that the produced alkali cellulose has a high bulk density, which makes it possible to charge a smaller reactor with a greater amount of the alkali cellulose in a subsequent etherification reaction step. Unfortunately, the use of a double-shaft kneader in a large scale production process requires a large capital investment.

One object of the present invention is to provide a method of preparing a cellulose derivative, particularly a cellulose ether or cellulose ester, with increased throughput. A preferred object of the present invention is to provide a method of preparing a cellulose derivative, particularly of a cellulose ether or cellulose ester with a high throughput while minimizing the use of capital-intensive production equipment.

### SUMMARY OF THE INVENTION

In one aspect of the present invention it has surprisingly been found that cellulose derivatives of high quality can be obtained when granulated cellulose-based material is used for the preparation of the cellulose derivatives. Unexpectedly, cellulose derivatives of essentially the same quality can be produced when using granulated cellulose-based material as in known processes wherein powdered cellulose-based material is used for alkalization and derivatization.

In another aspect of the present invention it has surprisingly been found that cellulose derivatives of high quality can be produced from pulp without processing pulp to a sheet. The processing of pulp to a sheet and grinding the sheet to produce cellulose in powder form, followed by alkalization and derivatization is the standard procedure of the prior art, but the processing of pulp to a sheet requires high capital investment.

Accordingly, one aspect of the present invention is the use of granulated cellulose-based material for the preparation of alkali cellulose and/or a cellulose derivative.

Another aspect of the present invention is the use of a cellulose-based material comprising agglomerated fibers for the preparation of alkali cellulose and/or a cellulose derivative.

Yet another aspect of the present invention is a method for preparing alkali cellulose and/or a cellulose derivative which comprises the steps of loading granulated cellulose-based material in a reactor and contacting the granulated cellulose-based material with an alkali solution.

Yet another aspect of the present invention is a method for preparing alkali cellulose and/or a cellulose derivative which comprises the steps of grinding pulp to a cellulose-based material, and contacting the cellulose-based material with an alkali solution without processing the wet pulp to a sheet.

### SHORT DESCRIPTION OF THE DRAWINGS

FIG. 1 illustrates an enlarged view on cellulose powder which is used in prior art processes for preparing alkali cellulose and cellulose derivatives.

FIG. 2 illustrates an enlarged view on granulated cellulose which is used for preparing alkali cellulose and/or a cellulose derivative according to the process of the present invention.

### DETAILED DESCRIPTION OF THE INVENTION

In one aspect of the present invention cellulose-based material in powder form is used as a starting material to obtain granulated cellulose-based material which is used in the process of the present invention. The term “cellulose-based material” as used herein means that the major part of the material consists of cellulose, but that it may comprise minor amounts of other materials, such as hemicelluloses or lignin. Preferably purified cellulose is used, which means cellulose fibers comprising a minor amount or no further material, particularly cellulose of soft wood, hard wood, cotton or bacterial origin, more preferably cellulose which is purified to at least 85 percent, most preferably to at least 90 percent purity, or any mixture of purified cellulose with any unpurified cellulose or polysaccharide, wherein the mixture comprises at least 60 percent cellulose, preferably at least 70 percent, more preferred at least 80 percent and most preferred at least 90 percent cellulose by weight. Preferably the crystallinity of the cellulose is low, however partially crystalline areas can be contained in the cellulose containing material. A particularly preferred starting material is wood cellulose, prepared, for example, from the known sulphite process or Kraft process. Other preferred starting materials are ground cotton linters, preferably purified cotton linters. The bulk density of the cellulose-based material in powder form depends on the type of cellulose, but in general the bulk density of the cellulose powder is 60 to 170 g/l, if the powder is charged in a container without any vibration automatically showing the unsettled bulk density. This corresponds to 100 to 300 g/l of “settled bulk density” that can be determined by using additional settling method (vibration).

A typical cellulose-based material in powder form that is used for the preparation of alkali cellulose and/or a cellulose derivative for example has the following particle size distribution: x(10 percent) is smaller than 60 micrometers, x(16 percent) is smaller than 70 micrometers, x(50 percent) is smaller than 200 micrometers, x(84 percent) is smaller than 300 micrometers, and x(90 percent) is smaller than 400 micrometers. Preferably, x(10 percent) is smaller than 60 micrometers, x(16 percent) is smaller than 70 micrometers, x(50 percent) is smaller than 150 micrometers, x(84 percent) is smaller than 200 micrometers, and x(90 percent) is smaller than 300 micrometers. In this particle size distribution x(n percent) is the diameter where n mass percent of the particles have a smaller equivalent diameter and 100−n mass percent have a larger equivalent diameter. The equivalent particle diameter x is the diameter of a circle having the same area as the area of the projection of a given particle. If larger particles, such as cellulose fibers of more than 1000 μm length are used as a starting material, the fibers usually are ground or cut, for example by knife mills, ball mills or table roller mills in dry or wet stage and optionally screened by means of suitable sieves. To obtain the cellulose-based material in powder form, cellulose fibrous material can be ground which has been produced in bales or sheets. The sheets can be in the form of endless roles or can be cut in individual pieces. Suitable grinding equipment is known in the art, for example knife grinders or roller mills. Knife grinders are commercially available, for example from Condux or Pallmann. Roller mills are commercially available, for example, from Hosokawa. The length of the cellulose fibers is shortened by grinding or cutting to a powder with desired particle size distribution.

The cellulose-based material in powder form can be granulated by any process or device known in the art. The granulation can be any process which is suitable to gather a cellulose-based material in powder form, including but not limited to ground cellulose fibers, into larger permanent free-flowing agglomerates or granules. Granulation can be achieved in “wet” granulation or “dry” granulation processes. In a wet granulation process the cellulose-based material in powder form is moistened with water or an organic solvent with or without any binder material under conditions to result in formation of a wet pasty mass which is then sized through a coarse sieve. The wet granules are dried and, if necessary, broken up again in a mill and screened to the desired size. In a dry granulation process the cellulose-based material in powder form is compacted with or without any binder material in the absence of a solvent. The compacted material is generally subjected to coarse grinding in a mill and screened to the desired size. Known devices for dry and wet granulation processes can be used, such as roller compactors, pelletizers, briquetting machines, extrusion processes with or without any binder material, a screw press, Kahl press comprising a plate with defined openings, or a granulating press.

Dry or wet granulation of cellulose-based materials in powder form is known in the art. However, the use of granulated cellulose-based material for the preparation of alkali cellulose and/or a cellulose derivative was not known prior to the present invention. U.S. Pat. No. 4,269,859 describes cellulose granules usable for pharmaceutical tablets, prepared by subjecting cellulose fibers to pressure (compacting) and crushing the resulting sheets (granulating). EP-A 970 181 discloses compacted and granulated cellulose containing material, particularly thermo mechanical pulp and chemo-thermo mechanical pulp as disintegrant in detergent tablets. EP-A 1 043 389 describes a disintegrant for detergent tablets prepared of purified cellulose in combination with a polymer, wherein the disintegrant can be prepared by granulating the cellulose/binder mixture. In a dry granulation process the press force usable for compaction, e.g. in a roller compactor, is preferably in the range from 5 to 100 kN/cm, more preferably in the range from 10 to 60 kN/cm, most preferably in the range from 10 to 30 kN/cm. The press forces correspond to moderate compaction pressure. If the press force is too high the compacted material might be too rigid and derivatisation rate may decrease. In wet granulation process with or without a binder material, pressure is not necessarily provided to the cellulose containing material.

The granulation of the cellulose-based material results in a material with an increased bulk density. The bulk density is generally at least 20 percent higher, preferably at least 40 percent higher, more preferably at least 70 percent higher than the non-granulated cellulose-based material in powder form. The unsettled bulk density of the cellulose-based material which is used in the process of the present invention preferably is in the range of 120 to 450 g/l, more preferably in the range of 200 to 350 g/l, most preferably in the range of 220 to 300 g/l. The settled bulk density preferably is in the range of 200 to 650 g/l, more preferably 200 to 500 g/l. The increased bulk density of the granulated cellulose-based material allows a higher throughput through the reactor. It is understood to those skilled in the art that settling of the powder in the reactor to increase its bulk density is not a practically feasible option on industrial production scale.

The granulated cellulose-based material preferably has the following particle size distribution: x(10 percent) is at least 60 micrometers, x(16 percent) is at least 70 micrometers, x(50 percent) is at least 200 micrometers, x(84 percent) is at least 300 micrometers, and x(90 percent) is at least 400 micrometers. More preferably, x(10 percent) is at least 65 micrometers, x(16 percent) is at least 80 micrometers, x(50 percent) is at least 300 micrometers, x(84 percent) is at least 500 micrometers, and x(90 percent) is at least 900 micrometers. Most preferably, x(10 percent) is at least 70 micrometers, x(16 percent) is at least 90 micrometers, x(50 percent) is at least 600 micrometers, x(84 percent) is at least 1000 micrometers, and x(90 percent) is at least 1200 micrometers. Preferably x(10 percent) is smaller than 2000 micrometers, x(16 percent) is smaller than 3000 micrometers, x(50 percent) is smaller than 7000 micrometers, x(84 percent) is smaller than 9000 micrometers, and x(90 percent) is smaller than 10,000 micrometers. More preferably x(10 percent) is smaller than 500 micrometers, x(16 percent) is smaller than 1000 micrometers, x(50 percent) is smaller than 4000 micrometers, x(84 percent) is smaller than 5000 micrometers, and x(90 percent) is smaller than 7000 micrometers. In this particle size distribution x(n percent) is the diameter where n mass percent of the particles have a smaller equivalent diameter and 100−n mass percent have a larger equivalent diameter. The equivalent particle diameter x is the diameter of a circle having the same area as the area of the projection of a given particle.

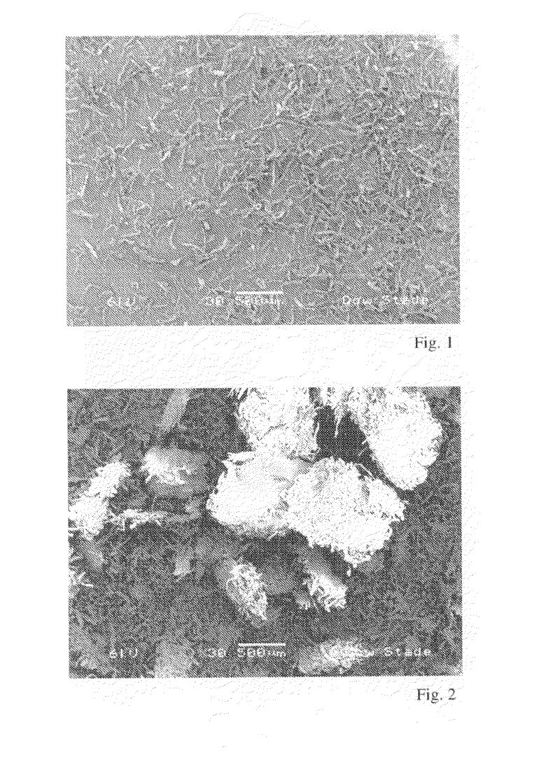

In another aspect of the present invention cellulose-based material comprising agglomerated fibers is used for the preparation of alkali cellulose and/or a cellulose derivative. The presence or absence of agglomerated fibers can be detected by Scanning Electron Microscopy (SEM). FIG. 1 shows the absence of agglomerated fibers in non-granulated cellulose powder. FIG. 2 shows granulated cellulose that comprises agglomerated fibers. Agglomerated fibers are generally an indication that a cellulose-based material has been granulated. In the process of the present invention cellulose-based material can be used that comprises agglomerated fibers as well as non-agglomerated fibers. However, the percentage of agglomerated fibers should be at least sufficiently high such that the bulk density is generally at least 20 percent higher, preferably at least 40 percent higher, more preferably at least 70 percent higher than in a corresponding cellulose-based material in powder form that does not comprise agglomerated fibers. Preferably, the cellulose-based material comprising agglomerated fibers has a bulk density and particle sizes within the ranges disclosed above for granulated cellulose-based material.

In a preferred embodiment of the present invention pulp is ground to a cellulose-based material, the cellulose-based material is optionally granulated and is contacted with an alkali solution without processing the pulp to a sheet before contacting the cellulose-based material with an alkali solution. Preferably the pulp is ground in its wet stage. More preferably, an aqueous suspension of cellulose fibers obtained in the pulping process is washed, bleached, and ground to comminute the fibers. Preferably an aqueous slurry comprising from 0.5 to 60 percent, more preferably from 1 to 10 percent in case of a ball mill or more preferably from 30 to 55 percent in case of refiner is ground, the percentage being based on the total weight of the slurry. Known devices can be used for grinding wet pulp, such as a ball mill.

The grinding of the pulp in its wet stage can be conducted such that directly a granulated cellulose-based material is obtained. The granulated cellulose-based material obtained by grinding of the wet pulp generally has a bulk density and a particle size as described above for the granulated material. The wet granules are dried and, if necessary, broken up again in a mill and screened to the desired size. Optionally the wet granules are contacted with an organic solvent, such as an alcohol like isopropanol or tertiary butanol, an ether like a mono- or dialkylether of mono-, di- or tripropylene glycol or mono-, di- or triethylene glycol; a cyclic ether like dioxane, an aromatic hydrocarbon like toluene, or a ketone like acetone or methyl isobutyl ketone or a mixture of two or more of these solvents, to facilitate the subsequent alkalization reaction. Other useful solvents are known in the art.

Alternatively, the wet pulp can be ground to a very small particle size and dried to produce a cellulose-based material in powder form. This cellulose-based material in powder form can be granulated as described further above. In both embodiments of wet grinding of pulp the step of producing sheets from cellulose pulp can be avoided, a step which requires sophisticated and expensive equipment.

The granulated material has increased bulk density compared to the powder material commonly used in cellulose derivatisation processes. This provides a well flowing material which can be easily handled, allowing one to charge an increased amount of cellulose-based material into a reactor as well as to increase the charging speed. The material possessing the good flowability can be conveyed with higher speed.

The granulated material can be charged into a reactor, wherein it is contacted with any solution necessary in a derivatisation process. Preferably the granulated material is contacted with a solution of an alkali metal hydroxide, preferably an aqueous solution of sodium hydroxide, to provide alkali cellulose. The alkali cellulose further can be contacted with any suitable reagent to result in a desired cellulose derivative, such as any cellulose ether or cellulose ester. Useful reagents to produce cellulose ethers or cellulose esters are known in the art. Preferred produced cellulose ethers are carboxy-C₁-C₃-alkyl celluloses, such as carboxymethyl celluloses; carboxy-C₁-C₃-alkyl hydroxy-C₁-C₃-alkyl celluloses, such as carboxymethyl hydroxyethyl celluloses; C₁-C₃-alkyl celluloses, such as methylcelluloses; C₁-C₃-alkyl hydroxy-C₁₋₃-alkyl celluloses, such as hydroxyethyl methylcelluloses, hydroxypropyl methylcelluloses or ethyl hydroxyethyl celluloses; hydroxy-C₁₋₃-alkyl celluloses, such as hydroxyethyl celluloses or hydroxypropyl celluloses; mixed hydroxy-C₁-C₃-alkyl celluloses, such as hydroxyethyl hydroxypropyl celluloses, or alkoxy hydroxyethyl hydroxypropyl celluloses, the alkoxy group being straight-chain or branched and containing 2 to 8 carbon atoms.

The alkalization and derivatisation steps are preferably conducted in a batch reactor. Although the production of the alkali cellulose and the reaction of the alkali cellulose with a suitable reagent to produce a cellulose derivative can be conducted in separate reactors, it is preferred to conduct the alkalization and derivatisation steps both in the same reactor. The capital expenditure for two separate equipments, such as the use of a double-shaft kneader in addition to a derivatisation reactor as taught in US-A 2002/0099203, can be avoided.

The process of the present invention provides an effective method of cellulose derivatisation which can be carried out at high speed and with an increased output of cellulose derivatives. The use of granulated cellulose-based material allows a considerably higher throughput of cellulose than in known processes. A given reactor can be loaded with more granulated cellulose-based cellulose than with a powdered dried cellulose, which allows a higher amount of produced cellulose derivative per reactor and time unit. Moreover, the granulated cellulose-based material possesses good flowability. Therefore, it can be conveyed to the reactor and charged into the reactor used for alkalization at a higher speed than powdered cellulose. This further increases the efficiency of the production of alkali cellulose and cellulose derivatives.

A further advantage is that the granulated cellulose-based material can be prepared apart from the derivatisation process, for example the granulated cellulose-based material can be prepared by any internal or external supplier and can be transported and stored easily. On the other side, since the granulation can be carried out by any known method, the granulation step can be made “online” between grinding of delivered cellulose material, such as in the form of sheets, rolls or bales and charging of the reactor without any further step.

### Experiment 1

### Comparative Example

450 g powdery cellulose with the unsettled bulk density of 110 g/l is charged to a horizontal steel reactor and the air is thoroughly replaced with nitrogen. The degree of filling of the reactor with this powdery cellulose is 81 percent. FIG. 1 illustrates a picture of the powdery cellulose taken by Scanning Electron Microscopy (SEM). Then 987 g of 50 percent aqueous caustic and 200 g of dimethylether as inert suspending aid are added under agitation for the activation of the cellulose. After 15 min of alkalization at 40° C. temperature 115 g of propylene oxide and 900 g of chloromethane are fed under agitation. The temperature is raised to 80° C. and the total reaction time is 240 min. Then the reactor pressure is released and the content is slurried with hot water of 90° C. and neutralized with the appropriate amount of acetic acid. The slurry is filtered and washed with additional hot water. The filter cake is then dried and milled. The substitution is determined by the ether cleavage method by Zeisel. The substitution is 29.5 percent methoxyl (MeO) and 4.0 percent hydroxypropoxyl (HpO). A viscosity of 3850 cps (=3850 mPa·s) is measured with a Brookfield Viscometer in a 1 weight percent aqueous solution at spindle 4. The analytical results of the produced hydroxypropyl methylcellulose (HPMC) are documented in Table 1.

### Experiment 2

### Inventive Example

Powdery cellulose is compacted in a roller compactor into compacted cellulose sheets (slips) applying a specific press force of 20 kN/cm to produce a sheet. The compacted sheet is subsequently broken up to form the granulated cellulose-based material. FIG. 2 illustrates a picture of the granulated cellulose-based material taken by Scanning Electron Microscopy (SEM). 450 g of the granulated cellulose-based material having an unsettled bulk density of 249 g/l is loaded into the reactor and the air is thoroughly replaced with nitrogen. Then 974 g of 50 percent aqueous caustic and 200 g of dimethylether as inert suspending aid are added under agitation for the activation of the cellulose. After 15 min of alkalization at 40° C. temperature 115 g of propylene oxide and 900 g of chloromethane are fed under agitation. The temperature is raised to 80° C. and the total reaction time is 241 min. Then the reactor pressure is released and the content is slurried with hot water of 90° C. and neutralized with the appropriate amount of acetic acid. The slurry is filtered and washed with additional hot water. The filter cake is then dried and milled. The substitution is determined by the ether cleavage method by Zeisel. The substitution is 30.5 percent methoxyl (MeO) and 4.0 percent hydroxypropoxyl (HpO). A viscosity of 3760 cps (=3760 mPa·s) is measured with a Brookfield Viscometer in a 1 weight percent aqueous solution at spindle 4. The analytical results of the produced hydroxypropyl methylcellulose (HPMC) are documented in Table 1.

### Experiment 3

### Inventive Example

Powdery cellulose is compacted in a roller compactor to produce compacted cellulose sheets (slips) using a specific press force of 20 kN/cm to a produce sheet. The compacted sheet is subsequently broken up to form the compacted, granulated cellulose-based material. 675 g of the granulated cellulose-based material having an unsettled bulk density of 249 g/l are loaded into the reactor and the air is thoroughly replaced with nitrogen. Then 1451 g of 50 percent aqueous caustic and 300 g of dimethylether as inert suspending aid are added under agitation for the activation of the cellulose. After 15 min of alkalization at ambient temperature 173 g of propylene oxide and 1350 g of chloromethane are fed under agitation and the temperature is raised to 80° C. and the total reaction time is 262 min. Then the reactor pressure is released and the content is slurried in hot water, neutralized and further processed as in Experiment 2. The analytical results of the produced hydroxypropyl methylcellulose (HPMC) are documented in Table 1.

The amount of 450 g powderous cellulose having a bulk density of 110 g/l as in Experiment 1 tills a 5 L reactor by 81 percent, 675 g of the same powderous cellulose would overfill this reactor by 22 percent (hypothetical degree of filling 122 percent). Using 675 g of granulated cellulose having a bulk density of 249 g/l as in the inventive Experiment 3 has a degree of filling of 54 percent in this reactor and thus increasing the throughput of this reactor accordingly.

TABLE 1

| | | Experiment 1 | Experiment 2 | Experiment 3 |
|---|---|---|---|---|
| | | (comparative) | (inventive) | (inventive) |
| Cellulose | g/l | 110 | 249 | 249 |
| unsettled | | | | |
| bulk density | | | | |
| Cellulose settled | g/l | 155 | 346 | 346 |
| bulk density | | | | |
| Produced HPMC, | g/l | 172 | 173 | 181 |
| unsettled | | | | |
| bulk density | | | | |
| Produced HPMC, | g/l | 256 | 244 | 285 |
| settled bulk | | | | |
| density | | | | |
| MeO | % | 29.5 | 30.5 | 30.0 |
| HpO | % | 4.0 | 4.0 | 3.5 |
| Moisture | % | 1.1 | 1.2 | 1.1 |
| NaCl | % | 0.3 | 0.3 | 0.3 |
| Viscosity | cps | 3850 | 3760 | 4320 |

| | |
|---|---|
| Color | White in all experiments |

The comparison between Experiment 1 (comparative example) and Experiment 2 (inventive example) illustrates that essentially the same cellulose derivative can be produced, regardless whether cellulose in powder form or granulated cellulose is used for the production of alkali cellulose and/or a cellulose derivative. The comparison between Experiment 1 (comparative example) and Experiment 3 (inventive example) illustrates that a higher amount of granulated cellulose than powdered cellulose can be loaded into the reactor, allowing a higher amount of produced cellulose derivative per reactor and time unit.

1. A method for preparing alkali cellulose and/or a cellulose derivative comprising the steps of
processing pulp to a cellulose-based material in the form of a sheet,
grinding the produced cellulose-based material,
granulating the ground cellulose-based material to increase its bulk density such that the granulated cellulose-based material has a particle size distribution such that x(10%) is at least 60 micrometers, x(16%) is at least 70 micrometers, x(50%) is at least 200 micrometers, x(84%) is at least 300 micrometers, and x(90%) is at least 400 micrometers, wherein x(n %) is the diameter where n mass percent of the particles have a smaller equivalent diameter and 100−n mass percent have a larger equivalent diameter and the equivalent particle diameter x is the diameter of a circle having the same area as the area of the projection of a given particle, loading granulated cellulose-based material into a reactor and
contacting the granulated cellulose-based material with an alkali solution.

2. A method for preparing alkali cellulose and/or a cellulose derivative comprising the steps of
grinding pulp to a cellulose-based material without processing the pulp to a sheet,
granulating the ground cellulose-based material to increase its bulk density such that the granulated cellulose-based material has a particle size distribution such that x(10%) is at least 60 micrometers, x(16%) is at least 70 micrometers, x(50%) is at least 200 micrometers, x(84%) is at least 300 micrometers, and x(90%) is at least 400 micrometers, wherein x(n %) is the diameter where n mass percent of the particles have a smaller equivalent diameter and 100−n mass percent have a larger equivalent diameter and the equivalent particle diameter x is the diameter of a circle having the same area as the area of the projection of a given particle, loading granulated cellulose-based material into a reactor and
contacting the granulated cellulose-based material with an alkali solution.

3. The method of claim 1 wherein the granulated cellulose-based material is contacted with an alkali solution and an etherifying or esterifying agent.

4. The method of claim 1 wherein the granulated cellulose-based material comprises agglomerated fibers.

5. The method of claim 1 wherein the granulated material has an unsettled bulk density in the range of 120 to 450 g/l or a settled bulk density in the range of 200 to 650 g/l.

6. The method of claim 1 wherein the granulated material has a particle size distribution such that x(10%) is at least 65 micrometers, x(16%) is at least 80 micrometers, x(50%) is at least 300 micrometers, x(84%) is at least 500 micrometers, and x(90%) is at least 900 micrometers.

7. The method of claim 5 wherein the granulated material has a particle size distribution such that x(10%) is at least 70 micrometers, x(16%) is at least 90 micrometers, x(50%) is at least 600 micrometers, x(84%) is at least 1000 micrometers, and x(90%) is at least 1200 micrometers.

8. The method of claim 1 wherein the granulated material has a particle size distribution such that x(10 percent) is smaller than 2000 micrometers, x(16 percent) is smaller than 3000 micrometers, x(50 percent) is smaller than 7000 micrometers, x(84 percent) is smaller than 9000 micrometers, and x(90 percent) is smaller than 10,000 micrometers.

9. The method of claim 1 wherein the granulated material has a particle size distribution such that x(10 percent) is smaller than 500 micrometers, x(16 percent) is smaller than 1000 micrometers, x(50 percent) is smaller than 4000 micrometers, x(84 percent) is smaller than 5000 micrometers, and x(90 percent) is smaller than 7000 micrometers.

10. The method of claim 1 wherein the cellulose-based material is contacted with an alkali solution and an etherifying or esterifying agent.

11. The method of claim 2 wherein the granulated cellulose-based material is contacted with an alkali solution and an etherifying or esterifying agent.

12. The method of claim 2 wherein the granulated cellulose-based material comprises agglomerated fibers.

13. The method of claim 2 wherein the granulated material has an unsettled bulk density in the range of 120 to 450 g/l or a settled bulk density in the range of 200 to 650 g/l.

14. The method of claim 2 wherein the granulated material has a particle size distribution such that x(10%) is at least 65 micrometers, x(16%) is at least 80 micrometers, x(50%) is at least 300 micrometers, x(84%) is at least 500 micrometers, and x(90%) is at least 900 micrometers.

15. The method of claim 13 wherein the granulated material has a particle size distribution such that x(10%) is at least 70 micrometers, x(16%) is at least 90 micrometers, x(50%) is at least 600 micrometers, x(84%) is at least 1000 micrometers, and x(90%) is at least 1200 micrometers.

16. The method of claim 2 wherein the granulated material has a particle size distribution such that x(10 percent) is smaller than 2000 micrometers, x(16 percent) is smaller than 3000 micrometers, x(50 percent) is smaller than 7000 micrometers, x(84 percent) is smaller than 9000 micrometers, and x(90 percent) is smaller than 10,000 micrometers.

17. The method of claim 2 wherein the granulated material has a particle size distribution such that x(10 percent) is smaller than 500 micrometers, x(16 percent) is smaller than 1000 micrometers, x(50 percent) is smaller than 4000 micrometers, x(84 percent) is smaller than 5000 micrometers, and x(90 percent) is smaller than 7000 micrometers.

18. The method of claim 2 wherein the cellulose-based material is contacted with an alkali solution and an etherifying or esterifying agent.
